(19) United States
(12) Patent Application Publication
(10) Pub. No.: US 2012/0210383 A1
(43) Pub. Date: Aug. 16, 2012

(54) PRESENTING STREAMING MEDIA FOR AN EVENT

(76) Inventors: Craig P. Sayers, Menlo Park, CA (US); Henri J. Suermondt, Sunnyvale, CA (US); Martin B. Scholz, San Francisco, CA (US)

(21) Appl. No.: 13/370,938

(22) Filed: Feb. 10, 2012

Related U.S. Application Data
(60) Provisional application No. 61/441,919, filed on Feb. 11, 2011.

(51) Int. Cl. H04N 7/173

(52) U.S. Cl. 725/116

(57) ABSTRACT

Systems, methods, and computer-readable and executable instructions are provided for presenting streaming media for an event. Presenting streaming media for an event can include receiving an outgoing message. Presenting streaming media for an event can also include evaluating the outgoing message to determine if the message is related to the event. Furthermore, presenting streaming media for an event can include taking an action with respect to presenting streaming media based on the relation to the event.

### RELATED APPLICATIONS

This patent application is related to, and claims priority to, U.S. provisional patent application Ser. No. 61/441,919, entitled “Presenting Streaming Media for an Event,” filed on Feb. 11, 2011, commonly assigned herewith, and hereby incorporated by reference in its entirety.

### BACKGROUND

Many events may include some portions that are more interesting to a viewer than other portions. For example, a long running race may be exciting to viewers at the beginning, when the lead runner is overtaken, or at the conclusion of the race. Certain events may also be more interesting to some viewers than to others. For example, a viewer in one country may find greater interest in a certain event than a viewer in a different country.

### BRIEF DESCRIPTION OF THE DRAWINGS

FIG. 1 is a flow chart illustrating an example of a method for presenting streaming media for an event according to the present disclosure.

FIG. 2 illustrates a block diagram of an example of a computer-readable medium in communication with processing resources for presenting streaming media for an event according to the present disclosure.

FIG. 3 illustrates a block diagram of an example of a computing system for presenting streaming media for an event according to the present disclosure.

### DETAILED DESCRIPTION

Examples of the present disclosure may include methods, systems, and computer-readable and executable instructions and/or logic. An example method for presenting streaming media for an event may include receiving an outgoing message and evaluating the outgoing message to determine if the message is related to the event. In an example, the method may also include taking an action with respect to presenting streaming media based on the relation to the event.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

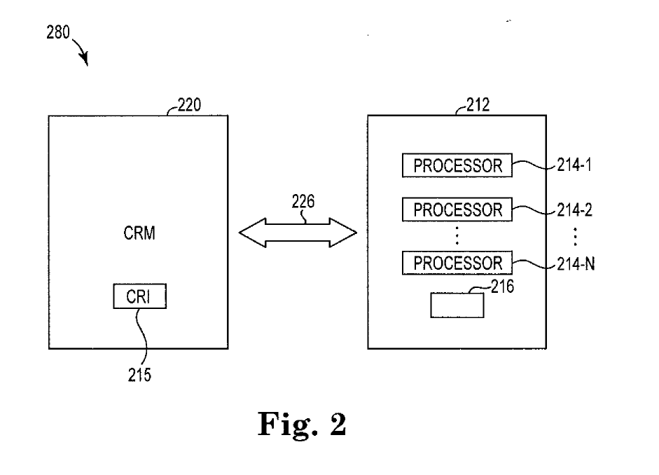

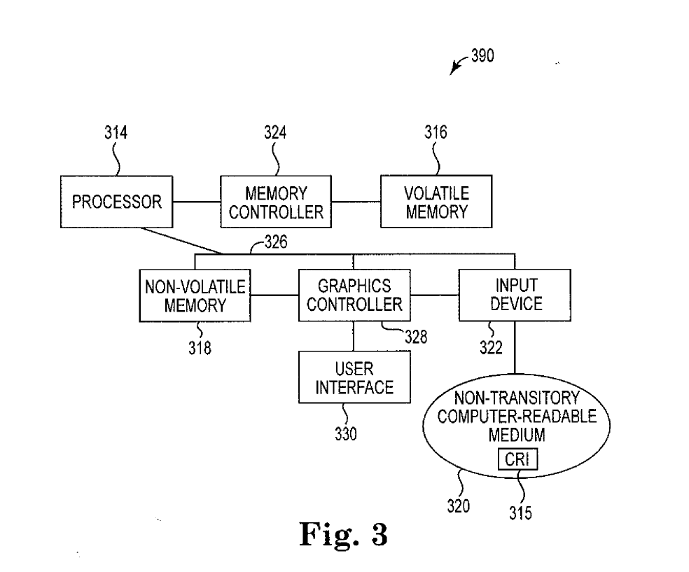

The figures herein follow a numbering convention in which the first digit or digits correspond to the drawing figure number and the remaining digits identify an element or component in the drawing. Similar elements or components between different figures may be identified by the use of similar digits. For example, 214 may reference element “14” in FIG. 2, and a similar element may be referenced as 314 in FIG. 3. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Events may include some portions that are more interesting to a viewer than other portions. For example, a viewer may lose interest in an event during the segments of the events that are of little interest to him or her. Viewer interest and/or excitement about an event can be evaluated by correlating social media with the event, and that knowledge can be used to select portions of the event the viewer found more interesting.

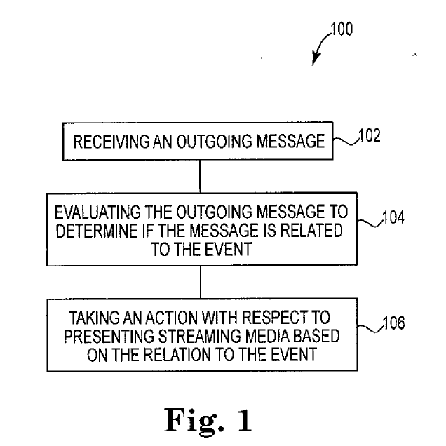

FIG. 1 is a flow chart illustrating an example of a method 100 for presenting streaming media for an event according to the present disclosure. At 102, an outgoing message is received. As used herein, receiving the message is not intended to mean receipt only at the address of an electronic device. The outgoing message can include a “tweet” made on Twitter®, a communication made on Facebook® or any other social media, a text message, a telephone call, an electronic mail message, a voicemail message, an answering machine message, or any other form of outgoing message. The outgoing message can be in relation to an event, a portion of an event, or it may not be in relation to an event. In an example, a user at an event “tweets” the event location and a comment regarding his or her interest in a specific portion of the event. More than one message can be received. For example, a subset of messages likely to be relevant can be received, or a random subset of messages can be received.

A “tweet” can include a message or posting to the Twitter® website that includes information about the user. This information can include what the user is doing, watching, thinking, or anything else that can be communicated via the website. Communications made via Facebook® or any other social media can include the divulgence of the same or similar information related to the user as sent in a “tweet”. Outgoing messages sent via a text message, a telephone call, an electronic mail message, a voicemail message, an answering machine message, or other outgoing message form can also include a similar divulgence of information related to the user as sent in a “tweet.”

Outgoing messages can be evaluated to see which messages are relevant to an event. In an example, a subset of the messages relevant to the event are retrieved and evaluated. The subset can be generated using the content and timing of the messages. For example, tweets which include the hashtag “#SFGiants” and were sent on day X can be more likely to be relevant to a baseball game played on day X by the San Francisco Giants. The tweets can be directly retrieved from Twitter® using their search application programming interface (API) without needing to examine all tweets. Messages can also be placed in subsets by examining who sent the message (e.g., authors who have previously been known to have relevant messages), where the message originated (e.g., messages sent from nearby the location of the event), and when the message was sent (e.g., messages written contemporaneously).

in an example, the event can include a live sporting event, a live concert, a live entertainment event, a single stream of content, or multiple streams of content. In an example, the event can be a television broadcast of a pre-recorded program. The single and multiple streams of content can be video content. In an example, the single and multiple streams of content can be transmitted by a wireless connection to a portable electronic device.

In another example, the event can be a running race, and a data stream transmitting video of the running race can be identified. The event can have multiple cameras capturing it, and a number of data streams transmitting video captured by the cameras can be identified. The outgoing message can identify at least one portion of the event. In an example, more than one outgoing message can be received from more than one source and more than one person or device.

At 104, the outgoing message is evaluated to determine if the message is related to the event. This can include determining an origin of the message. Determining the origin of the message can include determining the IP address of a personal computer from which the message originates. In an example, determining the origin of the message can include determining a wireless access point, a source cellular tower, or using global tracking to determine the location of a mobile device sending the message. The content of the message can also aid in determining the origin of the message. A user can disclose his or her physical location in the content of the outgoing message (e.g., disclosing his or her location in a Twitter® hashtag). For example, a user can include in a message, “Having a great time,” and in a Twitter® hashtag might include, “#YankeesGame.” A Twitter® hashtag can add additional context and metadata to a tweet, and Twitter® can support searching for all tweets containing such tags and the users who authored them.

Evaluating the outgoing message can also include determining the content of the outgoing message. In an example, the location of the user is determined, the location of an event is determined, and feedback regarding the event is determined. A user can use the outgoing message and its content to disclose his or her location, as well as the location of the event. The user can also use the message to disclose his or her proximity to the event. In an example, the user discloses his or her location in a Twitter® hashtag or Facebook® status update. The user can use a hashtag, “#NYCMarathon” to disclose his or her location in a tweet, and can use a status update on the Facebook® webpage that states, “Having so much fun at the NYC Marathon!” In a further example, a user can discuss his or her like, dislike, or neutral feelings about the event. The user can send a message in all capital letters suggesting excitement or extreme dismay over the event (e.g., “THIS CONCERT IS SO BORING!”, etc.).

Determining the origin and the content of the outgoing message can include determining which messages were made during the event from locations where the event could be viewed. Determining the origin and content can also include determining which messages mention the event and which messages mention concepts related to the event (e.g., an athlete in the event). The origin and content determinations can also include determining which messages are by users who are physically near the event location and which messages are made by users while watching the event. For example, an outgoing message can include, “John Doe just took over first place at the race—it happened right in front of me!” In an example, a user can be watching the event on television. A message can include, “This NYC marathon is so neat. I wish I was there in person and not watching it on television!” Determining the origin and content of the outgoing message can also include determining the origin and content of previous messages. The origin and content of an outgoing message can be compared to a different outgoing message by the same author. In an example, a user can have a string of messages disclosing origin and content. One message may be, “I'm at the Giant's game,” and another message from the same user can say, “Wow—what a hit!” The time of the outgoing message can also be determined.

A user's interest in a specific portion of the event can be determined based on the content of the outgoing message (e.g., “OMG! THE FIRST PLACE RUNNER JUST FELL IN THE RACE”, etc.). The user can disclose what it is about the event that is positive, negative, or neutral. In an example, the content of multiple outgoing messages from multiple uses can be determined. For example, there can be a increased number of outgoing messages when a performer sings a popular song at a rock concert, and a decreased number of outgoing messages when the performer sings a song the audience does not know.

A cumulative interest of multiple users can also be determined. Determining the cumulative interest can include determining a total number of outgoing messages related to an event and determining the location of a number of the users viewing the event. Also included in the determination of the cumulative interest can be determining positive, negative, and neutral feedback of the users viewing the event, determining the density of users with positive, negative, and neutral feedback, and determining the time of the user feedback. For example, if a predetermined number of people send a message about the event at time T, then the 30 seconds or other predetermined time period prior to T might be of increased interest. The interest level for a predetermined time period after T might also be of increased interest. For example, if a runner in a race falls, viewers of the event may be interested in seeing if the runner gets up and continues the race.

The cumulative interest of multiple users during specific portions of the event can be measured by periodically determining the total bandwidth of outgoing messages from devices connected to a wireless access point at the event or a cellular tower near the event.

In an example, an interesting portion and the specific time it occurred can be estimated on a per-user basis. A user can be typing a message about an exciting portion of the event, but the exciting portion may be over before the message is actually sent. In an example, the rate of a user's typing speed can be estimated and considered along with the length of an outgoing message to estimate an approximate time the typing began, which can coincide with the interesting portion. Comparisons between multiple users' messaging times can also be considered. In another example, the time of a known event and the time an outgoing message was sent can be considered in determining a time of an interesting event or event portion.

In an example, several outgoing messages can be received and evaluated. A message can be related to a particular event or portion of an event, while another message may not be related to the particular event or portion of the event. In an example, an outgoing message includes, “Loving the Giant's Game in San Francisco!” A different message includes, “Getting ice cream in Canada.” If the particular event is a San Francisco Giants baseball game, the latter outgoing message may not be related to the event. The determination of relatedness can be based on the origin and content of the outgoing message.

At 106, an action is taken with respect to presenting streaming media based on the relation to the event. In an example, taking the action can be based on at least one an origin, a content, the relation of each of the plurality of messages to the event, and the actual number of messages included in the plurality of messages. The quantity of messages involved can determine if the action is taken. An action can also be taken based on a user's positive, negative, or neutral interest in a specific portion of the event. The action can be taken in relation to the entire event, or it can be taken in relation to a portion or portions of the event. The action taken can include automatically selecting a highlight from the event. In an example, highlights of the event could be selected and generated by choosing a portion of the event marked by outgoing messages that meet a predetermined interest level. A highlight can be automatically selected and generated by using only those portions of collected streams that include a predetermined interest level. The interest can include positive feedback or negative feedback. In an example, a highlight can be generated of a football catch if 100 people send outgoing messages expressing interest in the catch. The interests can be conflicting. For example, a user who is a fan of Team A can have positive interest about a touchdown catch while a user of an opposing team can have negative interest about the same catch. A highlight can then be transmitted to an electronic device for viewing.

In an example, the criteria for the streamed highlight can be selected by a user operating an electronic device. A user can receive transmission of the data stream and select his or her desired criterion. In an example, the user may want to follow a certain athlete competing in an event. Outgoing messages may be monitored, and messages with content relating to the particular athlete, as well as the messages' origin and content, can be used to generate an automatic highlight.

Taking the action can also include generating publicity about the event. In an example, the portions of the event determined to be of higher interest in response to the origin and content of the outgoing messages can be used to generate publicity about the event. In an example, if a first portion of a rock concert resulted in a greater amount of outgoing messages than a second portion of the concert, data streams of the first portion can be used to generate publicity about the rock concert.

In another example, taking the action includes varying the compression ratio for the event. This can be done based on at least one of the origin and content of the message, as well as the interest. Data compression may allow for encoding information using fewer bits than an unencoded representation through the use of specific encoding schemes. Compression is useful because it can reduce the consumption of expensive resources, such as hard disk space or transmission bandwidth. A data compression ratio may be used to quantify a reduction in data-representation size produced by a data compression algorithm. A data compression ratio may be the ratio of the size or rate of the original data to the size or rate of the compressed data.

When an image is compressed, the file size may become smaller, but if the compression is too high, the image quality may degrade. For example, a low compression may result in better image quality. A compression quality is a measure of the amount of information that is discarded as a data stream is compressed. When a compression quality is very high, little information is lost, and the transmitted stream may be perceived by a viewer to be identical to an uncompressed stream. When compression quality is very low, so much information is discarded that the resulting stream may be a lower quality than the original. In an example, the lower quality stream may be blurry, jerky, or have visible artifacts.

Adjusting a measure of compression quality can allow for an efficient use of bandwidth. Furthermore, by coupling knowledge of a specific event with an outgoing message (e.g., a “tweet” on Twitter®), a higher measure of compression quality can be used when something interesting happens in an event, and a lower measure of compression quality can be used when something not as interesting is happening.

In an example, a compression ratio can be adjusted according to the time of event. The general characteristics of a certain event may be known, and it may be possible to estimate when important or interesting portions of an event may occur (e.g., the beginning or ending of a marathon running race). It may be possible to estimate within minutes or seconds the time of exciting portions of an event. This estimation can also be used in other actions taken in response to outgoing message origin, content, and interest levels. The compression ratio can be increased in times of lower interest (e.g., before a running race begins) and decreased in times of higher interest (e.g., the approach to the finish line in a running race).

During portions of an event that are not previously known to be of high interest, the outgoing messages can be monitored to determine origin, content, and interest level. For example, if the middle of particular running race is typically of little interest to viewers, a sudden increase in outgoing messages about that particular portion can trigger a change in a compression ratio. In response to increased interest in a portion of an event, the compression ratio can be decreased, and a higher quality data stream can be produced. A higher quality data stream can show the interesting portion in greater detail. Some user devices can support slow-motion replays, and a higher quality stream can improve the quality of those replays.

Taking the action can include generating a variable-speed playback broadcast of the event. This can allow for speeding through portions of the event with lower interest and slowing down for higher interest portions. In an example, the data stream can be broadcast at a normal speed at the beginning of a running race, and the speed can increase during the middle portion of the race. The speed can decrease in response to outgoing messages indicating interest in a portion of the race (e.g., a runner overtakes first place), and can increase at the conclusion of that portion. In an example, the playback speed can again decrease as the race concludes, and viewers want to see the finish.

In an example, taking the action can include personalizing a broadcast of the event based on the location of a broadcast viewer. In an example, an Olympic running race can be interesting in a certain portion to a user viewing from one country, while that portion may be less interesting to a user viewing from another country. Outgoing messages from users from a particular country or in a certain language can be considered, and a broadcast or streaming may be personalized for that group of users. In another example, Country A may play Country B in soccer, and the highlights for Country B's audience can be different from those of Country A's audience if based on outgoing messages. Country B's users may have sent messages unusually heavily when a certain player said something to a coach or a certain play was made. Using the content, origin, and interest indicated by the message, highlights personalized to Country B can be different than highlights personalized to Country A. A group of users including members with similar interests can also be considered, and the similar interests can be determined by analyzing the content of the users' outgoing messages. For example, users cheering for Country B can include messages in Language B and positive feedback when Team B scores, while users cheering for Country's A can include messages in Language A and positive feedback when Team A scores.

Other groups of users can also be constructed and used similarly. For example, users who are connected in a social network, users who subscribe to similar content, or users with similar demographics can be grouped.

Taking the action can also include filtering out a specific portion of the event for broadcast. In an example, a data stream of an event is received. This data stream can be a video stream. The data stream can be delayed by a predetermined time. Due to the time it takes to type or communicate an outgoing message, there can be a lag time between an exciting or interesting event portion and the receipt of the outgoing message or messages. By delaying the data stream by a predetermined amount of time, there can be time to receive an outgoing message or messages and decrease the compression ratio before the data streams are broadcast. In an example, this broadcast of the data streams can be transmitted to a portable electronic device by a wireless connection. This can be useful during a live streamed event. By delaying a data stream by a predetermined time (e.g., several seconds), a portion of higher interest can be broadcast in full, rather than just the aftermath being seen by viewers. For example, users may have expressed a lot of interest (e.g., “That runner just fell!”) at a certain portion of the event, and with a delay, a television viewer may be able to see the fall, rather than just the runner lying on the ground.

Similar techniques can be used to select from available video streams from the event. For example, a video stream could be selected from a camera that best shows the runner falling. More than one stream can also be broadcast. In an example, during a live event, a low resolution stream can be broadcast without any delay. Additional information to enhance the resolution can be broadcast, with a small delay, as a supplemental stream only during periods where the interest level was observed to be at an increased level. This can allow user devices to support a higher resolution reply of interesting portions without having to broadcast the entire event at the higher resolution. This can also prevent having to broadcast the entire event with a delay.

FIG. 2 illustrates a block diagram 280 of an example of a computer-readable medium (CRM) 220 in communication with a computing device 212, e.g., Java application server, having processor resources of more or fewer than 214-1, 214-2 . . . 214-N, that can be in communication with, and/or receive a tangible non-transitory computer readable medium (CRM) 220 storing a set of computer readable instructions 215 executable by one or more of the processor resources (e.g., 214-1, 214-2 . . . 214-N) for presenting streaming media for an event, as described herein. The computing device may include memory resources 216, and the processor resources 214-1, 214-2 . . . 214-N may be coupled to the memory resources 216.

Processor resources can execute computer-readable instructions 215 that are stored on an internal or external non-transitory computer-readable medium 220. A non-transitory computer-readable medium (e.g., computer readable medium 220), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), high definition digital versatile discs (HD DVD), compact discs (CD), and/or a solid state drive (SSD), flash memory, etc., as well as other types of machine-readable media.

The non-transitory computer-readable 220 medium can be integral, or communicatively coupled, to a computing device, in either in a wired or wireless manner. For example, the non-transitory computer-readable medium can be an internal memory, a portable memory, a portable disk, or a memory located internal to another computing resource (e.g., enabling the computer-readable instructions to be downloaded over the Internet).

The CRM 220 can be in communication with the processor resources (e.g., 214-1, 214-2 . . . 214-N) via a communication path 226. The communication path 226 can be local or remote to a machine associated with the processor resources 214-1, 214-2 . . . 214-N. Examples of a local communication path 226 can include an electronic bus internal to a machine such as a computer where the CRM 220 is one of volatile, non-volatile, fixed, and/or removable storage medium in communication with the processor resources (e.g., 214-1, 214-2 . . . 214-N) via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 226 can be such that the CRM 220 is remote from the processor resources (e.g., 214-1, 214-2 . . . 214-N) such as in the example of a network connection between the CRM 220 and the processor resources (e.g., 214-1, 214-2 . . . 214-N). That is, the communication path 226 can be a network connection. Examples of such a network connection can include a local area network (LAN), a wide area network (WAN), a personal area network (PAN), and the Internet, among others. In such examples, the CRM 220 may be associated with a first computing device and the processor resources (e.g., 214-1, 214-2 . . . 214-N) may be associated with a second computing device (e.g., a Java application server).

In an example, processor resources 214-1, 214-2 . . . 214-N coupled to the memory 216 can receive a plurality of outgoing messages. An origin for each of the plurality of outgoing messages can be determined, and a content for each of the plurality of outgoing messages can also be determined. The processor resources 214-1, 214-2 . . . 214-N coupled to the memory 216 can determine whether each of the plurality of outgoing messages is related to the event based on at least on of the origin and content of each of the plurality of messages. A cumulative interest in a number of specific portions of the event based on the content as it relates to the number of specific portions of each of the plurality of outgoing messages related to the event and dynamically generate highlights of the event with respect to the streaming media based on the determined cumulative interest can also be determined.

FIG. 3 illustrates a block diagram 390 of an example of a computing system 300 for presenting streaming media for an event according to the present disclosure. However, examples of the present disclosure are not limited to a particular computing system configuration. The computing system can control streaming of an event based the evaluation of the outgoing messages. Streaming media can include content that is is constantly received by and presented to an end-user while being delivered by a streaming provider. Streaming can include broadcasting, multicasting, delivery to mobile devices, internet delivery, and any appropriate media delivery method. The system 300 can include processor resources 314 and memory resources (e.g., volatile memory 316 and/or non-volatile memory 318) for executing instructions stored in a tangible non-transitory medium (e.g., volatile memory 316, non-volatile memory 318, and/or computer-readable medium 320) and/or an application specific integrated circuit (ASIC) including logic configured to perform various examples of the present disclosure. The volatile memory 316 and the non-volatile memory 318 may be computer readable media. A computer (e.g., a computing device) can include and/or receive a tangible non-transitory computer-readable medium 320 storing a set of computer-readable instructions (e.g., software) via an input device 322. As used herein, processor resources 314 can include one or a plurality of processors such as in a parallel processing system. Memory resources can include memory addressable by the processor resources 314 for execution of computer-readable instructions. The computer-readable medium 320 can include volatile and/or non-volatile memory such as random access memory (RAM), magnetic memory such as a hard disk, floppy disk, and/or tape memory, a solid state drive (SSD), flash memory, phase change memory, etc. In some examples, the non-volatile memory 318 can be a database including a plurality of physical non-volatile memory devices. In various examples, the database can be local to a particular system or remote (e.g., including a plurality of non-volatile memory devices 318). A computing device having processor resources can be in communication with, and/or receive a tangible non-transitory computer readable medium (CRM) 320 storing a set of computer readable instructions 315 (e.g., software) for presenting streaming media for an event, as described herein.

The processor resources 314 can control the overall operation of the system 300. The processor resources 314 can be connected to a memory controller 324, which can read and/or write data from and/or to volatile memory 316 (e.g., RAM). The memory controller 324 can include an ASIC and/or a processor with its own memory resources (e.g., volatile and/or non-volatile memory). The volatile memory 316 can include one or a plurality of memory modules (e.g., chips).

The processor resources 314 can be connected to a bus 326 to provide for communication between the processor resources 314, and other portions of the system 300. The non-volatile memory 318 can provide persistent data storage for the system 300. The graphics controller 328 can connect to a user interface 330, which can provide an image to a user based on activities performed by the system 300.

Each system can include a computing device including control circuitry such as a processor, a state machine, application specific integrated circuit (ASIC), controller, and/or similar machine. As used herein, the indefinite articles “a” and/or “an” can indicate one or more than one of the named object. Thus, for example, “a processor” can include one processor or more than one processor, such as a parallel processing arrangement.

The control circuitry can have a structure that provides a given functionality, and/or execute computer-readable instructions that are stored on a non-transitory computer-readable medium (e.g. non-transitory computer-readable medium 320). The non-transitory computer-readable medium can be integral, or communicatively coupled, to a computing device, in either in a wired or wireless manner. For example, the non-transitory computer-readable medium 320 can be an internal memory, a portable memory, a portable disk, or a memory located internal to another computing resource (e.g., enabling the computer-readable instructions to be downloaded over the Internet). The non-transitory computer-readable medium 320 can have computer-readable instructions 315 stored thereon that are executed by the control circuitry (e.g., processor) to provide a particular functionality.

The non-transitory computer-readable medium, as used herein, can include volatile and/or non-volatile memory. Volatile memory can include memory that depends upon power to store information, such as various types of dynamic random access memory (DRAM), among others. Non-volatile memory can include memory that does not depend upon power to store information.

Examples of non-volatile memory can include solid state media such as flash memory, EEPROM, phase change random access memory (PCRAM), among others. The non-transitory computer-readable medium can include optical discs, digital video discs (DVD), Blu-Ray Discs, compact discs (CD), laser discs, and magnetic media such as tape drives, floppy discs, and hard drives, solid state media such as flash memory, EEPROM, phase change random access memory (PCRAM), as well as other types of computer-readable media.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed:

1. A computer-implemented method for presenting streaming media for an event comprising:
receiving an outgoing message;
evaluating the outgoing message to determine if the message is related to the event; and
taking an action with respect to presenting streaming media based on the relation to the event.

2. The method of claim 1 wherein evaluating the outgoing message includes at least one of determining an origin of the outgoing message and determining a content of the outgoing message.

3. The method of claim 1 further comprising receiving a plurality of outgoing messages and taking the action based on at least one of an origin, a content, the relation of each of the plurality of messages to the event, and how many messages are included in the plurality of outgoing messages.

4. The method of claim 1 further comprising:
determining an interest in a specific portion of the event based on a content of the outgoing message as it relates to the specific portion of the event; and
taking the action based on at least one of an origin of the outgoing message, the content, the relation to the event, and the interest.

5. The method of claim 1 wherein receiving the outgoing message includes receiving at least one of a social media message, a text message, a telephone call, an electronic mail message, a voicemail message, and an answering machine message.

6. The method of claim 2 wherein determining the origin of the outgoing message includes at least one of monitoring IP addresses, monitoring cellular towers, monitoring content of the outgoing message, and monitoring global tracking on portable devices.

7. The method of claim 2 wherein determining the content of the outgoing message includes at least one of determining a location of a user, determining a location of the event, determining an author of the outgoing message, determining a time the outgoing message was sent, comparing the content of the outgoing message to a different outgoing message by a same author, and determining positive, negative, and neutral feedback regarding all or part of the event.

8. The method of claim 1 further comprising taking the action with respect to a portion of the event.

9. The method of claim 1 wherein taking the action includes automatically selecting a highlight from the event.

10. The method of claim 1 wherein taking the action includes generating publicity about the event.

11. The method of claim 1 wherein taking the action includes varying the compression ratio for the event.

12. The method of claim 1 wherein taking the action includes generating a variable-speed playback broadcast of the event.

13. The method of claim 1 wherein taking the action includes personalizing a broadcast of the event based on the interest of a broadcast viewer.

14. The method of claim 1 wherein taking the action includes filtering out a specific portion of the event for a broadcast.

15. A computer-readable non-transitory medium storing a set of instructions for presenting streaming media for an event executable by the computer to cause the computer to:
receive an outgoing message;
determine an origin of the outgoing message;
determine a content of the outgoing message;
determine whether the outgoing message is related to a specific portion of the event based on at least one of the origin and content;
determine an interest in the specific portion based on the content of the outgoing message as it relates to the specific portion;
decrease a data compression ratio of the streaming media in response to an increased determined interest in the specific portion; and
increase the data compression ratio of the streaming media in response to a decreased determined interest in the specific portion.

16. A system for presenting streaming media for an event, comprising:
a computing device including:
a memory;
a processor coupled to the memory, to:
receive a plurality of outgoing messages;
determine an origin for each of the plurality of outgoing messages;
determine a content for each of the plurality of outgoing messages;
determine whether each of the plurality of outgoing messages is related to the event based on at least one of the origin and content of the plurality of outgoing messages;
determine a cumulative interest in a number of specific portions of the event based on the content as it relates to the number of specific portions of each of the plurality of outgoing messages related to the event; and
dynamically generate highlights of the event with respect to the streaming media based on the determined cumulative interest.

17. The system of claim 16 wherein determining the cumulative interest includes at least one of determining a total number of outgoing messages related to the event, determining positive, negative, and neutral feedback of the users viewing the event, determining the density of the users viewing the event with positive, negative, or neutral feedback, determining the time of the user feedback, and determining the location of a number of the users viewing the event.
